(19) United States
(12) Patent Application Publication
(10) Pub. No.: US 2025/0042788 A1
(43) Pub. Date: Feb. 6, 2025

(54) AMMONIA-CONTAINING WASTEWATER TREATMENT METHOD AND APPARATUS THEREOF

(71) Applicant: HAN-LIN LIN, New Taipei City (TW)

(72) Inventors: HAN-LIN LIN, New Taipei City (TW); KENG-HAO YANG, New Taipei City (TW)

(21) Appl. No.: 18/365,240

(22) Filed: Aug. 4, 2023

(51) Int. Cl. C02F 1/72; C02F 1/58

(52) U.S. Cl. CPC C02F 1/727; C02F 1/586; C02F 2101/16; C02F 2201/003; C02F 2209/14; C02F 2209/225; C02F 2209/40; C02F 2209/44

(57) ABSTRACT

Disclosed are an ammonia-containing wastewater treatment method and an apparatus, of which a main structure includes an ammonia wastewater holding tank receiving therein ammonia-containing wastewater, at least one ammonia nitrogen detection element detecting ammonia nitrogen content of the ammonia-containing wastewater, at least one aeration device connected to the ammonia wastewater holding tank, an oxygen transfer coefficient calculation device in information connection with the aeration device. The aeration device includes an aeration time controller and a gas flowrate controller. As such, a total mass of oxygen entering the ammonia wastewater treatment tank can be precisely controlled by adjusting output time and output amount per unit time of the aeration device and calculating an oxygen transfer coefficient-aeration flowrate relationship of the aeration device, so that a ratio between the ammonia nitrogen mass and the oxygen mass can be controlled to have ammonium nitrogen first oxidized into nitrite before being oxidized into nitrate.

### TECHNICAL FIELD OF THE INVENTION

The present invention relates to an ammonia-containing wastewater treatment method and an apparatus thereof that precisely control ammonia oxidation reaction into ammonia anaerobic oxidation reaction.

### DESCRIPTION OF THE PRIOR ART

Ammonia nitrogen refers to amine compounds that are present in the forms of ammonia (NH₃) or ammonium ion (NH₄⁺). Ammonia nitrogen of such forms is the most dangerous form of all sorts of nitrogen and is an indicator of water pollution, and exhibits damages to the environment in various aspects. Ammonia nitrogen contained in wastewater comes largely from organic substances or chemicals that contain nitrogen. Generally, metabolism of microorganisms is used to reduce ammonia nitrogen back to nitrogen gas, and such a mechanism involves mainly nitrification and de-nitrification. However, such a mechanism is a high energy consuming process that requires supply of organic carbon sources and is gradually replaced by anaerobic ammonia oxidation that has various advantages of shorter reaction pathway, lower aeration power, reduced chemical adding amount, and reduced amount of slurry.

However, the operation control strategy of the above-mentioned anaerobic ammonia oxidation reaction mainly resides on controlling various conditions of pH value, temperature, supply of air, and slurry detention time to inhibit the activity of nitrobacter to prevent nitrite nitrogen from being oxidized into nitrate nitrogen. However, such a control strategy, when put into practice, demonstrates the following problems and drawbacks that require further improvement.

Firstly, the commonly adopted dissolved oxygen concentration control solutions involve total water content and ammonia nitrogen concentration that change from time to time, and variation of temperature that is influenced by the environment and would consequently have a relatively high error in respect of the actual oxygen content. A relatively low dissolved oxygen concentration may not prompt the reaction; while a relatively high dissolved oxygen concentration makes nitrides over-oxidized into nitrates and also inhibits anaerobic ammonia oxidizing bacteria.

Secondly, some ammonia oxygen consumes alkalinity of water during conversion into nitrides so as to lower the pH value. Consequently, adjustment by adding alkali agents becomes necessary, otherwise the oxidation rate of ammonia and the total nitrogen removal rate would continuously drop down. This kind of control solutions is incapable of inhibiting the growth of.

### SUMMARY OF THE INVENTION

In view of the above problems, the present invention aims to provide a ammonia-containing wastewater treatment method and an apparatus thereof, which are capable of controlling, in a precise manner, ammonia oxidation into anaerobic ammonia oxidation.

The primary objective of the present invention is to avoid control of the concentration of oxygen dissolved in water and to use an oxygen transfer coefficient-aeration flowrate relationship of an aeration device to precisely control a ratio between an ammonia nitrogen mass and an oxygen mass to make ammonium nitrogen, before being oxidized into nitrate, only oxidized into nitrite to react with the remaining ammonium nitrogen into nitrogen gas, achieving an ammonia wastewater treatment result of high efficiency, high precision, and being toxicant free.

To achieve the above objective, a main structure of the present invention comprises: an ammonia wastewater holding tank, at least one ammonia nitrogen detection element, at least one aeration device, and an oxygen transfer coefficient calculation device, wherein the ammonia wastewater holding tank receives and holds therein ammonia-containing wastewater; the ammonia nitrogen detection element detects ammonia nitrogen content of the ammonia-containing wastewater; the aeration device is arranged to connect to the ammonia wastewater holding tank to supply an oxygen-containing gas to the ammonia wastewater holding tank, and the aeration device comprises an aeration time controller that controls output time and a gas flowrate controller that controls output amount per unit time; and the oxygen transfer coefficient calculation device is in information connection with the aeration device to calculate an oxygen transfer coefficient-aeration flowrate relationship of the aeration device, in order to operate the aeration device to keep a ratio between an ammonia nitrogen mass of the ammonia-containing wastewater that participates in an ammonia oxidation reaction and an oxygen mass between 1:1.5 to 1:2.

When a user practices the ammonia-containing wastewater treatment method according to the present invention, an ammonia nitrogen detection element is first arranged in the ammonia wastewater holding tank to detect the ammonia nitrogen content of the ammonia-containing wastewater, and the aeration device is operated to supply the oxygen-containing gas into the ammonia wastewater holding tank, and also, the aeration amount of the aeration device is calculated and recorded according to the output time and the output amount per unit time set by the aeration time controller and the gas flowrate controller, and then, the oxygen transfer coefficient calculation device can be used to calculate the oxygen transfer coefficient-aeration flowrate relationship of the aeration device to precisely control and operate the aeration device to keep the ammonia nitrogen mass of the ammonia-containing wastewater that participates in the ammonia oxidation reaction and the oxygen mass at 1:1.5 to 1:2, in order to have ammonium nitrogen (NH₄⁺), before being oxidized into nitrate (NO₃⁻), first oxidized into nitrite (NO₂) to allow the remaining mass of ammonium nitrogen to directly enter the anaerobic ammonia oxidation reaction. Thus, by means of the oxygen transfer coefficient-aeration flowrate relationship, the ratio between the ammonia nitrogen mass and the oxygen mass can be accurately and freely controlled to enhance overall reaction efficiency.

By means of the above techniques, the problems of the prior art operation control strategy of ammonia oxidation reaction combined with anaerobic ammonia oxidation reaction that the error of controlling oxygen content in the dissolved oxygen concentration control operation solution is relatively high, and instability occurring in the control method of adding alkali agents to adjust the pH value of water can be overcome to achieve the above-mentioned advantages.

### BRIEF DESCRIPTION OF THE DRAWINGS

FIG. 1 is a flow chart illustrating steps of a preferred embodiment of the present invention.

FIG. 2 is a schematic view illustrating a structure of the preferred embodiment of the present invention.

FIG. 3 is a schematic view demonstrating a flow of reaction according to the present invention.

FIG. 4 is a flow chart illustrating steps of another preferred embodiment of the present invention.

FIG. 5 is a schematic view illustrating a structure of said another preferred embodiment of the present invention.

FIG. 6 is a flow chart illustrating steps of a further preferred embodiment of the present invention.

FIG. 7 is a schematic view illustrating a structure of said further preferred embodiment of the present invention.

### DETAILED DESCRIPTION OF THE PREFERRED EMBODIMENT

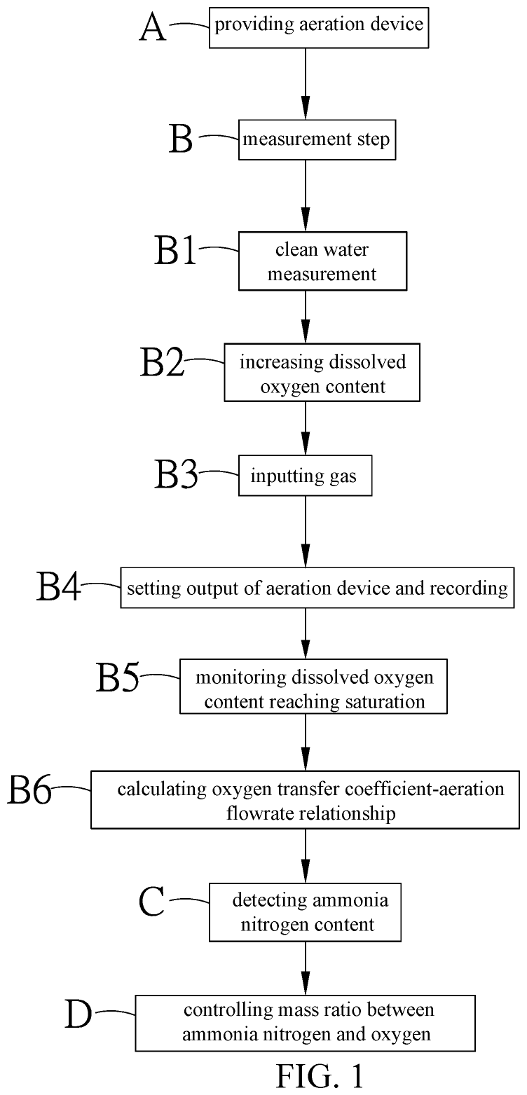

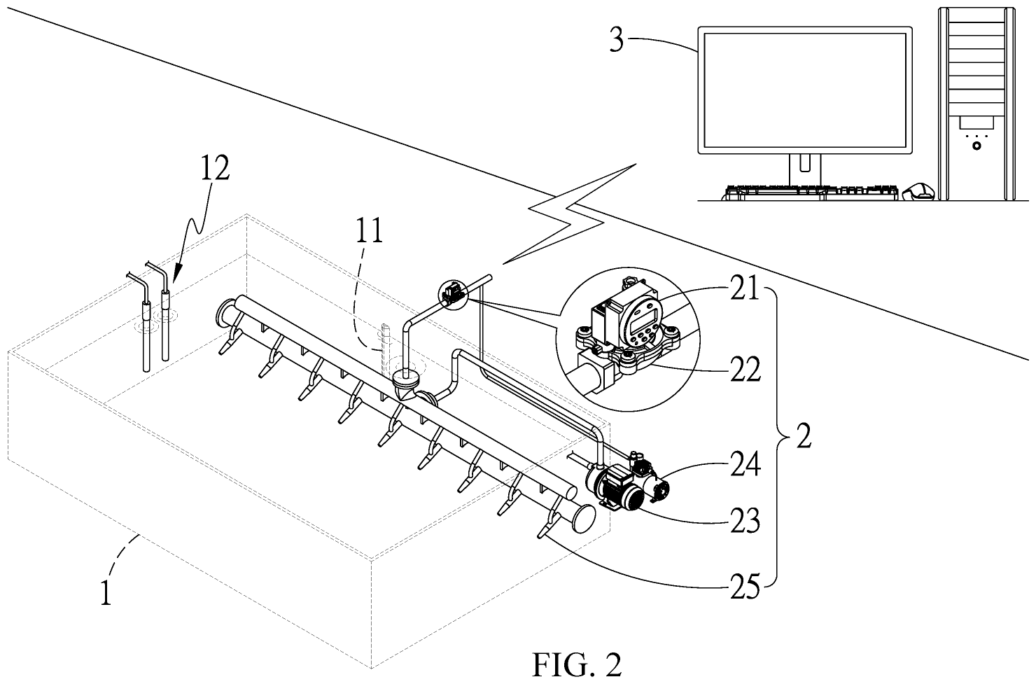

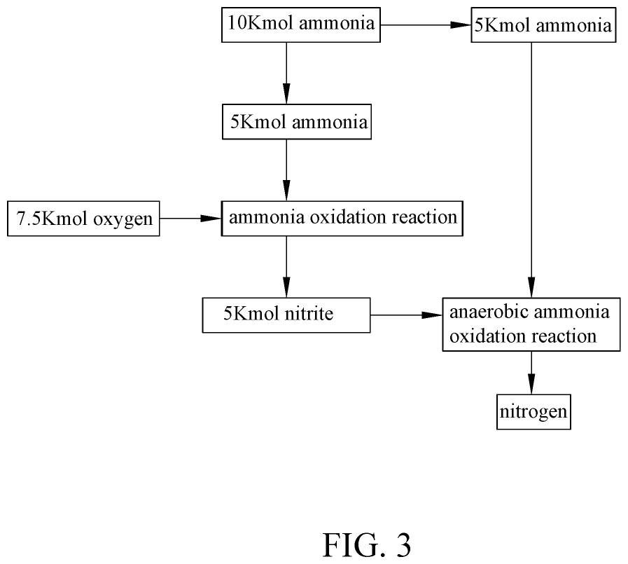

Referring to FIGS. 1-3, which are respectively a flow chart illustrating steps of a preferred embodiment of the present invention, a schematic view illustrating a structure of the preferred embodiment of the present invention, and a schematic view demonstrating a flow of reaction according to the present invention, it is clearly seen from the drawings that the present invention includes:
an ammonia wastewater holding tank 1, which receives and holds therein ammonia-containing wastewater;
an ammonia nitrogen detection element 11, which detects ammonia nitrogen content of the ammonia-containing wastewater;
at least one aeration device 2, which is arranged to connect to the ammonia wastewater holding tank 1 to supply an oxygen-containing gas to the ammonia wastewater holding tank 1, wherein the aeration device 2 comprises an aeration time controller 21 that controls output time and a gas flowrate controller 22 that controls an output amount per unit time; and
an oxygen transfer coefficient calculation device 3, which is in information connection with the aeration device 2 to calculate a relationship between oxygen transfer coefficient and aeration flowrate of the aeration device 2, in order to operate the aeration device 2 to keep a ratio between an ammonia nitrogen mass of the ammonia-containing wastewater that participates in an ammonia oxidation reaction and an oxygen mass between 1:1.5 to 1:2.

In the above, the aeration device 2 can be a combination of a circulation pump 23, a pressure pump 24, and a sprayer 25, or a combination of a blower, a diffuser tube, and a diffuser tray. Operations that can be carried out by the oxygen transfer coefficient calculation device 3 as Step (B) for calculation that may includes a clean water sorption measurement process, a clean water desorption measurement process, and a mixing liquid tail gas measurement process, this being only difference of specific operations and not limited to any specific details in this invention. In the instant embodiment, a combination of a circulation pump 23, a pressure pump 24, and a sprayer 25 is taken as an example of the aeration device 2, and the oxygen transfer coefficient calculation device 3 that is operable for the clean water desorption measurement process is provided as an example. Thus, the present invention provides an ammonia-containing wastewater treatment method, which comprises the following main steps:
(A) providing aeration device, wherein at least one aeration device 2 is arranged to connect to an ammonia wastewater holding tank 1;
(B) measurement step:
(B1) clean water measurement, wherein clean water is added into the ammonia wastewater holding tank 1,
(B2) increasing dissolved oxygen content, wherein dissolved oxygen content of the clean water is increased, and a dissolved oxygen sensor 12 is applied to detect the dissolved oxygen content reaching a high point (oversaturation),
(B3) inputting gas, wherein the aeration device 2 is operable to input an oxygen-containing gas into the clean water,
(B4) setting output of aeration device and recording, wherein an aeration time controller 21 and a gas flowrate controller 22 of the aeration device 2 are operated to set an output time and an output amount per unit time of the aeration device 2 and recording an aeration amount of the aeration device 2,
(B5) monitoring dissolved oxygen content reaching saturation, wherein the dissolved oxygen sensor 12 is operated to monitor the dissolved oxygen content of the ammonia-containing wastewater until reaching saturation, and
(B6) calculating oxygen transfer coefficient-aeration flowrate relationship, wherein a relationship between the oxygen transfer coefficient and the aeration flowrate of the aeration device 2 is calculated by the oxygen transfer coefficient calculation device 3 according to the output time, the output amount per unit time, and the aeration amount;
(C) detecting ammonia nitrogen content, wherein at least one ammonia nitrogen detection element 11 arranged in the ammonia wastewater holding tank 1 is operated to detect an ammonia nitrogen mass of ammonia-containing wastewater; and
(D) controlling mass ratio between ammonia nitrogen and oxygen, wherein the aeration device 2 is operated to make a ratio of an ammonia nitrogen mass of the ammonia-containing wastewater that participates in an ammonia oxidation reaction and an oxygen mass kept at 1:1.5 to 1:2 to make ammonia nitrogen (NH₄⁺) first oxidized into nitride (NO₂) before being oxidized into nitrate (NO₃⁻) to allow a remaining mass of ammonia nitrogen to directly enter an anaerobic ammonia oxidation reaction.

The above description provides an understanding to the structure of the present invention, and based on a corresponding operation of such a structure, an advantage of precisely controlling change from the ammonia oxidation reaction to the anaerobic ammonia oxidation reaction. It can be seen from the drawings that the treatment method of the present invention is not restrained by concentration issues and is applicable to wastewater accommodation troughs from low concentration (cultivation ponds) to high concentration (wastewater plants), and to operate, the ammonia wastewater holding tank 1 is necessarily provided with the ammonia nitrogen detection element 11 arranged therein, so that before an operation of removal of ammonia by the aeration device 2, the ammonia nitrogen detection element 11 uses a fixed quantity of ammonia-containing wastewater in the ammonia wastewater holding tank 1 to calculate the ammonia nitrogen content, for example 100 mgN/L NH₄⁺ being detected in 100 m³ of ammonia-containing wastewater implying the mass of ammonia nitrogen is 10 kg. However, the sequence of operation of Step (C) and Step (B) is not vital and the purpose is only to obtain the ammonia nitrogen mass and the oxygen mass separately, and the present invention is embodied by performing Step (B) earlier.

To calculate the oxygen transfer coefficient-aeration flowrate relationship of the aeration device 2, the oxygen transfer coefficient of the aeration device 2 must be known first, and then, the oxygen transfer coefficient-aeration flowrate relationship can be determined. The oxygen transfer coefficient is also referred to as volumetric oxygen transfer coefficient (K_{L}a), which is the product of liquid membrane mass transfer coefficient K_{L} and gas liquid specific surface area a, yet the gas liquid specific surface area a of bubbles is hard to measure, and thus, the present invention uses the time period for dissolved oxygen content per unit volume to change from 0 to saturation, or from oversaturation to saturation, in combination with the aeration amount that is outputted from the aeration device 2 during such a time period to obtain, in an alternative way, the oxygen transfer coefficient-aeration flowrate relationship of the aeration device 2. In the instant embodiment, clean water desorption measurement process is taken as an example for illustration, and the clean water desorption measurement process can obtain the oxygen transfer coefficient-aeration flowrate relationship of the aeration device 2 in a more accurate way, yet a large amount of clean water must be introduced first. Thus, in Steps (B1-B2), clean water must be added into the ammonia wastewater holding tank 1 first, and the dissolved oxygen content of the clean water is increased to a high point (oversaturation). In a practical operation, hydrogen peroxide (H₂O₂) can be added in the clean water to quickly increase the dissolved oxygen content of the clean water, and when oversaturation is reached, as being measured by means of the dissolved oxygen sensor 12, the method goes into Step (B3).

Further, in Steps (B3-B6), the circulation pump 23 and the sprayer 25 of the aeration device 2 are operated to pump water into the clean water, and at the same time, the pressure pump 24 is operated to pump in the oxygen-containing gas (such as air), in order to have the oxygen-containing gas mixed into the clean water in the sprayer 25 to be then delivered into the ammonia wastewater holding tank 1. The gas flowrate controller 22 can be used to set the output amount per unit time for the aeration device 2, wherein a flowrate electromagnetic valve that is mounted to the pressure pump 24 and connected with a pipeline of the sprayer 25 is taken as an example for the gas flowrate controller 22 for calculation and recording the aeration amount of the aeration device 2. Then, the dissolved oxygen sensor 12 can be similarly applied to monitor the dissolved oxygen content of the clean water until reaching saturation, and then, the oxygen transfer coefficient calculation device 3 can be applied to calculate the oxygen transfer coefficient-aeration flowrate relationship of the aeration device 2. In the instant embodiment, a computer is taken as an example for the oxygen transfer coefficient calculation device 3.

Next, the aeration time controller 21 is operated to set the output time of the aeration device 2. In the instant embodiment, a timer arranged at one side of the gas flowrate controller 22 is taken as an example for the aeration time controller 21. The formula (output time X output amount per unit time=aeration amount) is then applied such that the value of the actual mass of oxygen contained in the oxygen-containing gas supplied to the aeration device 2 can be precisely controlled. This, in combination with the known ammonia nitrogen mass of the ammonia-containing wastewater in the ammonia wastewater holding tank 1, allows the aeration device 2 to be operated in such a way as to hold the ratio between the mass of ammonia nitrogen of the ammonia-containing wastewater that participates in the ammonia oxidation reaction and the mass of oxygen mass between 1:1.5 to 1:2, in order to make ammonium nitrogen (NH₄⁺) oxidized into nitride (NO₂⁻) before being oxidized into nitrate (NO₃⁻) to directly enter an anaerobic ammonia oxidation reaction. If molar mass-kmol is taken as an example for the ammonia nitrogen mass and the oxygen mass, and presumably, the relationship between aeration flowrate and oxygen transfer coefficient is calculated as 10 m³/min, then the aeration time controller 21 can be controlled to open for 45-60 seconds in order to supply oxygen of 7.5-10 kmol, making the ratio between the ammonia nitrogen mass that participates in the ammonia oxidation reaction and the oxygen mass kept between 1:1.5 to 1:2. In the instant embodiment, opening for 45 second (generating 7.5 kmol oxygen) and the ratio being controlled to be 1:1.5 is taken as example for illustration. Under this condition, among 10 kmol ammonium nitrogen (NH₄⁺), 5 kmol ammonium nitrogen, together with 7.5 kmol oxygen, go on with the ammonia oxidation reaction: 5NH₄⁺+7.50₂→5NO₂⁻+5H₂O+10H⁺, and such a reaction generates 5 kmol nitrite (NO₂⁻) that go, in combination with the remaining 5 kmol of ammonium nitrogen (NH₄⁺), into the anaerobic ammonia oxidation reaction: 5NH₄⁺+5NO₂⁻→5N₂+10H₂O, such that all the ammonium nitrogen is decomposed into nitrogen gas and water, and no nitrate (NO₃⁻) is generated in such a process, and no nitrite (NO₂) remains, achieving an ammonia wastewater treatment result of high efficiency, high precision, and being toxicant free.

However, the performance of the ammonia oxidation reaction and the above-mentioned anaerobic ammonia oxidation reaction may necessarily be implemented with catalysis of microorganisms, and thus, the above reaction formula and the molar mass data are idealistic reference data and are taken by neglecting carbon-hydrogen-oxygen compounds. In other words, if the influence caused by microorganisms is included in the reaction formula, then the calculation must be done on the basis of actual measurements, such as 1 kmol of oxygen (O₂) being converted into 31.998 kg, and the relationship between the aeration flowrate and the oxygen transfer coefficient being actually 1 m³/min and 4.1/hr, to precisely control the aeration flowrate, in addition to the range of time period for one-time opening being changed to 30-120 seconds, the control performed by the aeration time controller 21 also needs a closing period of 150-600 seconds, and thus, the actually desired output amount of oxygen is set to 19 kg/d, making the ratio of the ammonia nitrogen mass and the oxygen mass controlled to be 1:1.9. Under this condition, among 10 kg of ammonium nitrogen (NH₄⁺—N), 5.7 kg ammonium nitrogen among participates, together with 19 kg of oxygen, in the ammonia oxidation reaction: NH₄⁺+1.440₂+0.0496CO₂→0.01C₅H₇NO₂+0.99NO₂⁻+0.97H₂O+1.99H⁺, and the reaction generates 5.7 kg of nitrite (NO₂⁻—N) that, together with the remaining 4.3 kg of ammonium nitrogen (NH₄+), go into the anaerobic ammonia oxidation reaction: NH₄⁺+1.32NO₂+0.066HCO₃⁻+0.13H⁺→1.02N₂+0.26NO₃⁻+0.066CH₂O_{0.5}N_{0.15}+2.03H₂O, so that all the ammonium nitrogen is decomposed into nitrogen gas and a minor amount of nitrate, wherein the presence of CO₂, C₅H₇NO₂, HCO₃⁻, and CH₂O_{0.5}N_{0.15} and the minute variation of mole number indicate the influence of participation of microorganisms in the reaction. Of course, the minor amount of nitrate, in general, does not cause nitrification, or the nitrate generated by nitrification causes only very little influence on the microorganisms. Further, the above reaction is known, and the essence of the present invention resides in the control of the ratio between the ammonia nitrogen mass and the oxygen mass, and simplicity may be taken herein for easy illustration.

Further, if the user does not intend to decompose all of ammonium nitrogen in one time, it is possible to freely adjust the supplied mass of oxygen, such as supplying only 10 kg of oxygen to allow only 3 kg of ammonium nitrogen, among 10 kg of ammonium nitrogen (NH₄⁺), to conduct the ammonia oxidation reaction with 10 kg of oxygen and to allow 3 kg of nitrite (NO₂⁻) generated with the reaction to go, in combination with 2.3 kg ammonium nitrogen (NH₄⁺) of the remaining ammonium nitrogen, into the anaerobic ammonia oxidation reaction, with 4.7 kg of ammonium nitrogen (NH₄⁺) being finally left. Thus, the user may, based on actual needs, control the aeration device 2 to adjust the supplied mass of oxygen for achieving free and precise control of the performance of the anaerobic ammonia oxidation reaction. Further, the ratio between the ammonia nitrogen mass and the oxygen mass is preferably 1:1.6 to 1:1.9 to ensure the activation of an ammonia oxidation reaction and also to ensure an excessive amount of oxygen to cause oxidation of ammonium nitrogen or nitrite into nitrate.

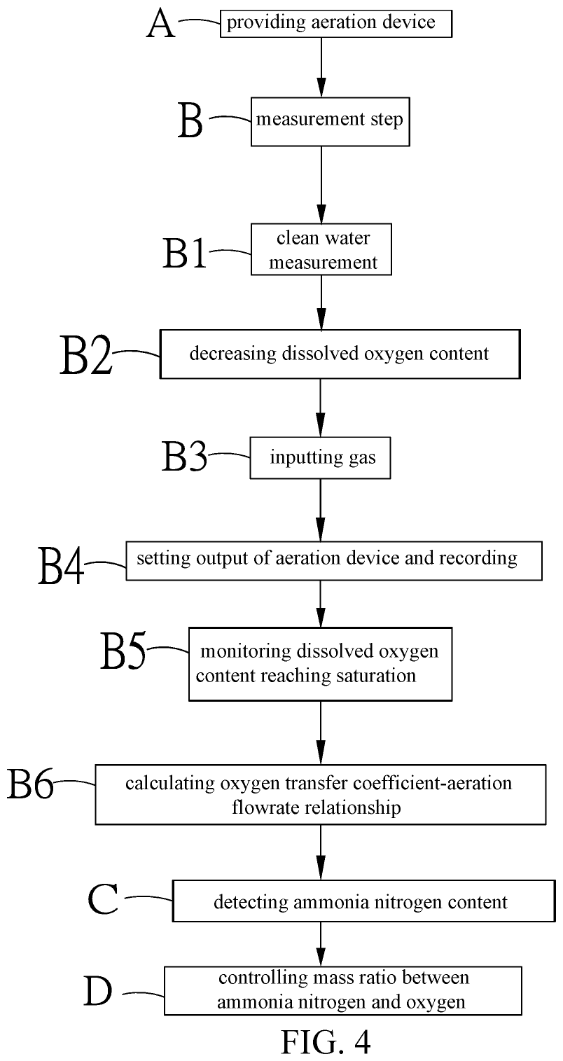

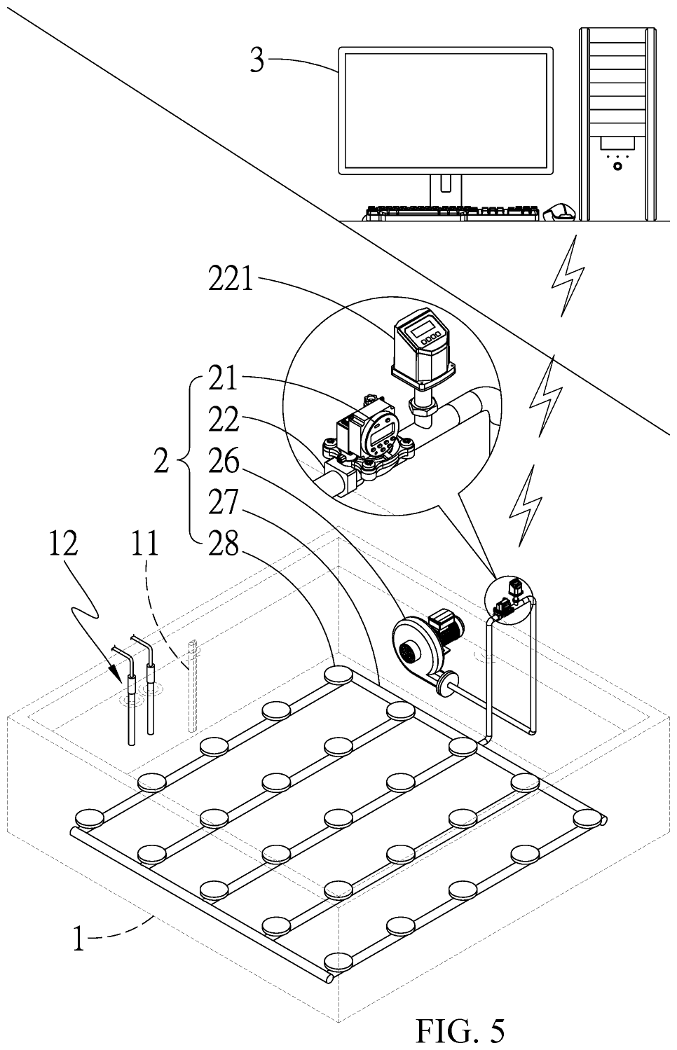

Referring to FIGS. 4 and 5, which are respectively a flow chart illustrating steps of another preferred embodiment of the present invention, and a schematic view illustrating a structure of said another preferred embodiment of the present invention, it is clearly seen from the drawings that the primary difference of the instant embodiment from the previous embodiment is that the aeration device 2 is changed to a combination of a blower 26, a diffuser tube 27, and a diffuser tray 28, and the calculation operation of the oxygen transfer coefficient calculation device 3 is changed to the clean water sorption measurement process that is taken as an example for illustration. Thus, in the instant embodiment, the ammonia-containing wastewater treatment method comprises the following main steps:
(A) providing aeration device, wherein at least one aeration device 2 is arranged to connect to an ammonia wastewater holding tank 1;
(B) measurement step:
(B1) clean water measurement, wherein clean water is added into the ammonia wastewater holding tank 1,
(B2) decreasing dissolved oxygen content, wherein dissolved oxygen content of the clean water is decreased, and a dissolved oxygen sensor 12 is applied to detect the dissolved oxygen content reaching a low point,
(B3) inputting gas, wherein the aeration device 2 is operable to input an oxygen-containing gas into the clean water,
(B4) setting output of aeration device and recording, wherein an aeration time controller 21 and a gas flowrate controller 22 of the aeration device 2 are operated to set an output time and an output amount per unit time of the aeration device 2 and recording an aeration amount of the aeration device 2, and the aeration device 2 uses at least one gas flowmeter 221 arranged at one side of the aeration device 2 to record the aeration amount,
(B5) monitoring dissolved oxygen content reaching saturation, wherein the dissolved oxygen sensor 12 is operated to monitor the dissolved oxygen content of the ammonia-containing wastewater until reaching saturation, and
(B6) calculating oxygen transfer coefficient-aeration flowrate relationship, wherein a relationship between the oxygen transfer coefficient and the aeration flowrate of the aeration device 2 is calculated by the oxygen transfer coefficient calculation device 3 according to the output time, the output amount per unit time, and the aeration amount;
(C) detecting ammonia nitrogen content, wherein at least one ammonia nitrogen detection element 11 arranged in the ammonia wastewater holding tank 1 is operated to detect an ammonia nitrogen mass of ammonia-containing wastewater; and
(D) controlling mass ratio between ammonia nitrogen and oxygen, wherein the aeration device 2 is operated to make a ratio of an ammonia nitrogen mass of the ammonia-containing wastewater that participates in an ammonia oxidation reaction and an oxygen mass kept at 1:1.5 to 1:2 to make ammonia nitrogen (NH₄⁺) first oxidized into nitride (NO₂) before being oxidized into nitrate (NO₃⁻) to allow a remaining mass of ammonia nitrogen to directly enter an anaerobic ammonia oxidation reaction.

In Step (A), the aeration device 2 is arranged such that the blower 26 conveys the oxygen-containing gas along the diffuser tube 27 to the diffuser tray 28 that is disposed on the bottom of the ammonia wastewater holding tank 1 to allow the oxygen-containing gas to be uniformly driven via the diffuser tray 28 into the clean water. Further, in the embodiment, the clean water sorption measurement process is taken as an example for illustration, and similarly, a large amount of the clean water is introduced first, and in Step (B2), the dissolved oxygen content of the clean water is lowered down to a low point. In a practical operation, dissolved NaSO₃ may be added to consume oxygen, and also, to prevent the agent from aggregating together to interfere with the operation of measurement conducted by the dissolved oxygen sensor 12. Although the amount of the agent used may be affected by the environmental temperature or preservation of the agent, yet it only needs that NaSO₃ is completely dissolved, and minor over-dosing does not influence of the measurement result of the dissolved oxygen sensor 12. If it is not possible to lower down the low point, CoCl₂ may be added to increase the rate of consuming dissolved oxygen. The clean water sorption measurement process makes it not necessary to convey a large amount of oxygen, making the cost relatively low, and using the diffuser tray 28 to pump in air makes it possible to quickly dissolve oxygen in water, and this is more efficient for obtaining the oxygen transfer coefficient-aeration flowrate relationship of the aeration device 2. Further, in Step (B4), the gas flowmeter 221 is applied to directly measure the gas input amount at the input port of the gas flowrate controller 22 and this helps eliminate the need of calculation by applying the output time and the output amount per unit time. The remaining operation is similar to that of the previous embodiment, and repeated description will be omitted herein.

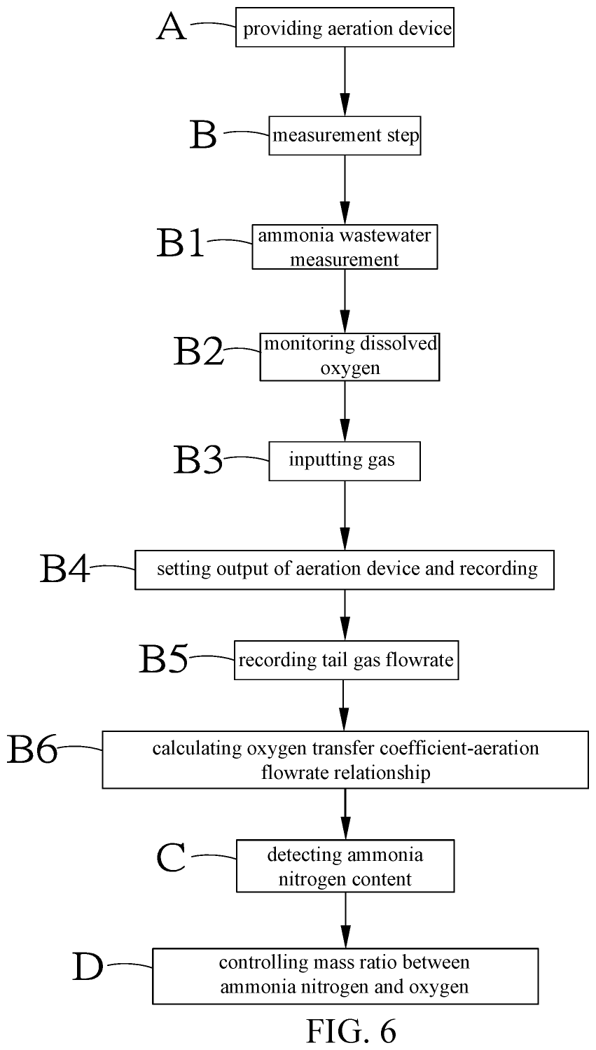

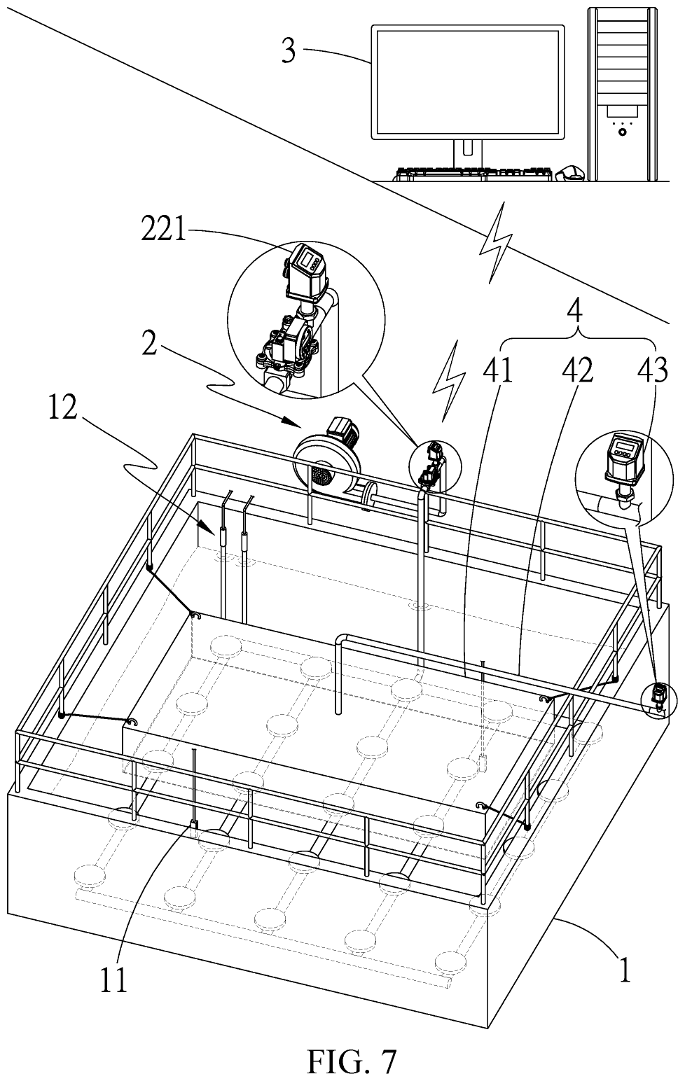

Referring to FIGS. 6 and 7, which are respectively a flow chart illustrating steps of a further preferred embodiment of the present invention, and a schematic view illustrating a structure of said further preferred embodiment of the present invention, it is clearly seen from the drawings that the instant embodiment is generally similar to the previous embodiments, and only the calculation operation carried out by the oxygen transfer coefficient calculation device 3 is changed to the mixing liquid tail gas measurement process that is taken as an example for illustration. Thus, in the instant embodiment, the ammonia-containing wastewater treatment method comprises the following main steps:
(A) providing aeration device, wherein at least one aeration device 2 is arranged to connect to an ammonia wastewater holding tank 1;
(B) measurement step:
(B1) ammonia wastewater measurement, wherein ammonia-containing wastewater is added into the ammonia wastewater holding tank 1,
(B2) monitoring dissolved oxygen, wherein a dissolved oxygen sensor 12 is applied to monitor a dissolved oxygen level at a current temperature,
(B3) inputting gas, wherein the aeration device 2 is operable to input an oxygen-containing gas into the ammonia-containing wastewater,
(B4) setting output of aeration device and recording, wherein an aeration time controller and a gas flowrate controller of the aeration device 2 are operated to set an output time and an output amount per unit time of the aeration device 2 and recording an aeration amount of the aeration device 2,
(B5) recording tail gas flowrate, wherein a the tail gas collection device 4 arranged on a surface of the ammonia wastewater holding tank 1 is applied to record a tail gas flowrate of the tail gas collection device 4, and
(B6) calculating oxygen transfer coefficient-aeration flowrate relationship, wherein an oxygen transfer coefficient-aeration flowrate relationship of the aeration device 2 is calculated by the oxygen transfer coefficient calculation device 3 according to the output time, the output amount per unit time, the aeration amount, and the tail gas flowrate;
(C) detecting ammonia nitrogen content, wherein at least one ammonia nitrogen detection element 11 arranged in the ammonia wastewater holding tank 1 is operated to detect an ammonia nitrogen mass of ammonia-containing wastewater; and
(D) controlling mass ratio between ammonia nitrogen and oxygen, wherein the aeration device 2 is operated to make a ratio of an ammonia nitrogen mass of the ammonia-containing wastewater that participates in an ammonia oxidation reaction and an oxygen mass kept at 1:1.5 to 1:2 to make ammonia nitrogen (NH₄⁺) first oxidized into nitride (NO₂) before being oxidized into nitrate (NO₃⁻) to allow a remaining mass of ammonia nitrogen to directly enter an anaerobic ammonia oxidation reaction. The mixing liquid tail gas measurement process is applicable in a situation where clean water is not allowed to add into the ammonia wastewater holding tank 1 at the implementation site, such as in a situation where the ammonia wastewater holding tank 1 already has ammonia-containing wastewater therein. The tail gas collection device 4 includes a top-floating gas hood 41 and a gas collection tube 42. The top-floating gas hood 41 is suspended on the water surface of the ammonia-containing wastewater to cover a large area, and a side surface of the top-floating gas hood 41 is partly immersed under the water surface, while a part of the side surface is above the water surface and defines a gas hermetic space, and a top surface is connected to the gas collection tube 42. A flowmeter 43 is arranged on the gas collection tube 42. When the aeration device 2 supplies gas into the ammonia-containing wastewater, in addition to the gas flowmeter 221 recording the aeration amount, the flowmeter 43 arranged on the gas collection tube 42 also records the tail gas flowrate collected in the top-floating gas hood 41, and a difference between the aeration amount and the tail gas flowrate is then used to determine the oxygen transfer coefficient-aeration flowrate relationship of the aeration device 2. The remaining operation is similar to those of the previous embodiments, and repeated description will be omitted herein

I claim:

1. An ammonia-containing wastewater treatment method, which comprises the following main steps:
(A) connecting at least one aeration device to an ammonia wastewater holding tank;
(B) operating an oxygen transfer coefficient calculation device to calculate an oxygen transfer coefficient-aeration flowrate relationship of the aeration device;
(C) operating at least one ammonia nitrogen detection element arranged in the ammonia wastewater holding tank to detect an ammonia nitrogen mass in ammonia-containing wastewater; and
(D) operating the aeration device such that a ratio between an ammonia nitrogen mass of the ammonia-containing wastewater that participates in an ammonia oxidation reaction and an oxygen mass is kept at 1:1.5 to 1:2 to make ammonium nitrogen (NH₄⁺) first oxidized into nitrite (NO₂⁻) before being oxidized into nitrate (NO₃⁻) to allow a remaining mass of ammonia nitrogen to directly enter an anaerobic ammonia oxidation reaction.

2. The ammonia-containing wastewater treatment method according to claim 1, wherein the ratio between the ammonia nitrogen mass and the oxygen mass 1:1.6 to 1:1.9.

3. The ammonia-containing wastewater treatment method according to claim 1, wherein Step (B) comprises:
Step (B1), adding clean water into the ammonia wastewater holding tank;
Step (B2), decreasing dissolved oxygen content of the clean water, and applying a dissolved oxygen sensor to detect the dissolved oxygen content reaching a low point;
Step (B3), operating the aeration device to input an oxygen-containing gas into the clean water;
Step (B4), operating an aeration time controller and a gas flowrate controller of the aeration device to set an output time and an output amount per unit time of the aeration device and recording an aeration amount of the aeration device;
Step (B5), operating the dissolved oxygen sensor to monitor the dissolved oxygen content of the ammonia-containing wastewater until reaching saturation; and
Step (B6), calculating the oxygen transfer coefficient-aeration flowrate relationship of the aeration device by means of the oxygen transfer coefficient calculation device according to the output time, the output amount per unit time, and the aeration amount.

4. The ammonia-containing wastewater treatment method according to claim 1, wherein Step (B) comprises:
Step (B1), adding clean water into the ammonia wastewater holding tank;
Step (B2), increasing dissolved oxygen content of the clean water, and applying a dissolved oxygen sensor to detect the dissolved oxygen content reaching a high point (oversaturation);
Step (B3), operating the aeration device to input an oxygen-containing gas into the clean water;
Step (B4), operating an aeration time controller and a gas flowrate controller of the aeration device to set an output time and an output amount per unit time of the aeration device, and recording an aeration amount of the aeration device;
Step (B5), operating the dissolved oxygen sensor to monitor the dissolved oxygen content of the ammonia-containing wastewater until reaching saturation; and
Step (B6), calculating the oxygen transfer coefficient-aeration flowrate relationship of the aeration device by means of the oxygen transfer coefficient calculation device according to the output time, the output amount per unit time, and the aeration amount.

5. The ammonia-containing wastewater treatment method according to claim 1, wherein Step (B) comprises:
Step (B1), adding ammonia-containing wastewater into the ammonia wastewater holding tank;
Step (B2), applying a dissolved oxygen sensor to monitor a dissolved oxygen level at a current temperature;
Step (B3), operating the aeration device to input an oxygen-containing gas into the ammonia-containing wastewater;
Step (B4), operating an aeration time controller and a gas flowrate controller of the aeration device to set an output time and an output amount per unit time of the aeration device, and recording an aeration amount of the aeration device;
Step (B5), applying a tail gas collection device arranged on a surface of the ammonia wastewater holding tank to record a tail gas flowrate of the tail gas collection device; and
Step (B6), calculating the oxygen transfer coefficient-aeration flowrate relationship of the aeration device by means of the oxygen transfer coefficient calculation device according to the output time, the output amount per unit time, the aeration amount, and the tail gas flowrate.

6. The ammonia-containing wastewater treatment method according to claim 3, wherein the aeration device comprises at least one gas flowmeter arranged at one side of the aeration device to record the aeration amount.

7. The ammonia-containing wastewater treatment method according to claim 4, wherein the aeration device comprises at least one gas flowmeter arranged at one side of the aeration device to record the aeration amount.

8. The ammonia-containing wastewater treatment method according to claim 5, wherein the aeration device comprises at least one gas flowmeter arranged at one side of the aeration device to record the aeration amount.

9. An ammonia-containing wastewater treatment apparatus, mainly comprising:
an ammonia wastewater holding tank, which receives and holds therein ammonia-containing wastewater;
at least one ammonia nitrogen detection element, which detects ammonia nitrogen content of the ammonia-containing wastewater;
at least one aeration device, which is arranged to connect to the ammonia wastewater holding tank to supply an oxygen-containing gas to the ammonia wastewater holding tank, wherein the aeration device comprises an aeration time controller that controls output time and a gas flowrate controller that controls output amount per unit time; and
an oxygen transfer coefficient calculation device, which is in information connection with the aeration device to calculate an oxygen transfer coefficient-aeration flowrate relationship of the aeration device, in order to operate the aeration device to keep a ratio of an ammonia nitrogen mass of the ammonia-containing wastewater that participates in an ammonia oxidation reaction and an oxygen mass between 1:1.5 to 1:2.

10. The ammonia-containing wastewater treatment apparatus according to claim 9, wherein the ratio between the ammonia nitrogen mass and the oxygen mass 1:1.6 to 1:1.9.

11. The ammonia-containing wastewater treatment apparatus according to claim 9, wherein a dissolved oxygen sensor is arranged in the ammonia wastewater holding tank to record a variation curve of dissolved oxygen content of the ammonia-containing wastewater.

12. The ammonia-containing wastewater treatment apparatus according to claim 9, wherein a tail gas collection device is arranged on a surface of the ammonia wastewater holding tank to record a tail gas flowrate floating to water surface during an aeration process of the aeration device.
